(19) United States
(12) Patent Application Publication
(10) Pub. No.: US 2007/0028754 A1
(43) Pub. Date: Feb. 8, 2007

(54) Photonic sequence paradigm

(75) Inventor: Glyn Michael Hall, Louisa, VA (US)

Correspondence Address: GLYN M. HALL, P.O. BOX 75, HADENSVILLE, VA, 23067, US

(73) Assignee: Glyn Michael Hall, Hadensville, VA (US)

(21) Appl. No.: 11/495,891

(22) Filed: Jul. 31, 2006

Related U.S. Application Data
(60) Provisional application No. 60/703,881, filed on Aug. 1, 2005.

(51) Int. Cl. G10H 1/34; G10H 3/00

(52) U.S. Cl. 84/745

(57) ABSTRACT

A method and apparatus are provided to help users understand chord theory by employing a novel visual and tactile harmonic note strand paradigms, so arranged in a note-to-chord and next step-note relationships for chord structure and flow. Flow referring to the succession of chords played on a musical instrument to create the underlying harmonic chorus for melodic cadence. The Photonic Sequence keyboard array actuates users to perform specific notes within an appropriate sequence of step-notes. Visual Information including Numbers, Letters, Colors, and Icons consisting of Round, Square, Triangles, Rectangular, or Oval Shapes may be used to represent these notes that comprise the Photonic Sequence Paradigm Octaves and its original music tablature.

### CROSS-REFERENCE to RELATED APPLICATIONS

Provisional Application No. 60/703,881

### STATEMENT REGARDING FEDERALLY SPONSORED RESEARCH OR DEVELOPMENT

“Not Applicable”

### REFERENCE TO SEQUENCE LISTING, A TABLE, OR COMPUTER PROGRAM LISTING COMPACT DISC APPENDIX

“Not Applicable”

### BACKGROUND OF INVENTION

Learning music theory, especially note to chord relationships, and learning to apply that special knowledge to a musical instrument has proven problematic for novice musicians because of the use of traditional music scale models, which have made learning music theory overly complicated. Even intermediate and advanced musicians with average intelligence, fail to understand these harmonic relationships of notes related to the creation of Major, Minor, and Diminished Diads, Triads, and Complex Seven, Nine, eleven and Thirteen Chords. This dilemma is caused by the traditional way music notes are commonly placed in their order of sequence in traditional Western Music Scales.

Classic Western Music Scales are based on ascending-descending structures and fail to visually conjoin music-notes to comprise the harmonic relationships of chords. For novice musicians it is excessively confusing for unrelated music-notes of traditional Western Music Scale structures to be represented conjoined with the specific notes found in the harmonic frequency relationships of chords. An entry-level situation in learning music theory is to understand and perform music notes on many instruments to produce desired chords and melodies, while avoiding notes that are not related to the harmonic relationship with those chords. Very few people intuitively relate to harmonic relationships of music-notes and novice musicians have great difficulty remembering what notes to play and what notes to avoid. In the history of music technology there have been many devices developed in the attempt to eradicate this problem.

### BRIEF SUMMARY OF INVENTION

Methods paradigms and an apparatus are provided to fast track novice musicians to learn music theory basics and intermediate musicians to learn advanced theory by employing simplified visual harmonic note recognition techniques, with a novel Western Music Scale Paradigm and innovative MIDI-Keyboard keypad array. In one aspect users are taught to play specified notes in a daisy-chain sequence to construct simple and complex chords. This preferred system is comprised by visual representation of harmonic note to chord relationships of every chord accompanied by visual and audio feedback to identify and compare these note to chord relationships with the standard piano-style keypad array. Music notes comprised in chords are represented in a suitable manner with a LED display to identify the specific note's numeric and name. This display is positioned horizontally over the both key pad arrays to identify specific location of the note's relationship to chords.

### BRIEF DESCRIPTION OF THE SEVERAL VIEWS OF THE DRAWINGS

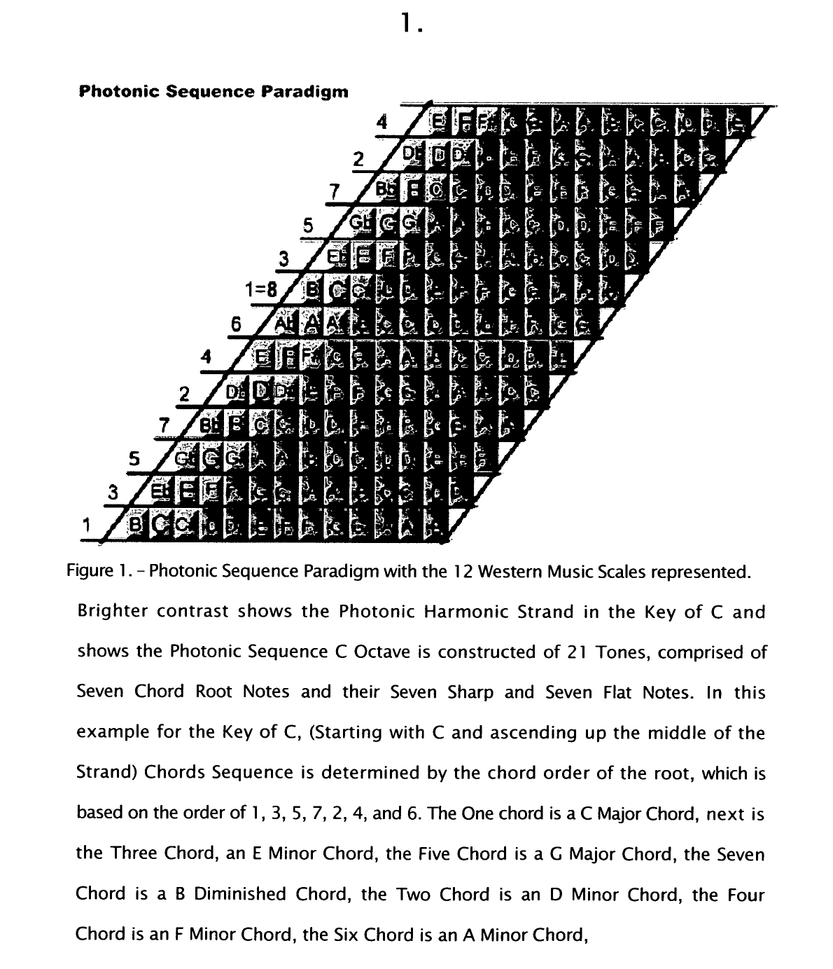

1. FIG. 1—Shows the Photonic Sequence Paradigm, reading from left to right, The Classic Axis of Seven out of Twelve Western Music Key Scales are alternately conjoined to create the Photonic Sequence Axis; that reads in columns diagonally from the bottom to the top of the paradigm. This Photonic Sequence Axis illustrates the advanced Twenty-One Note Harmonic Octave Strand.

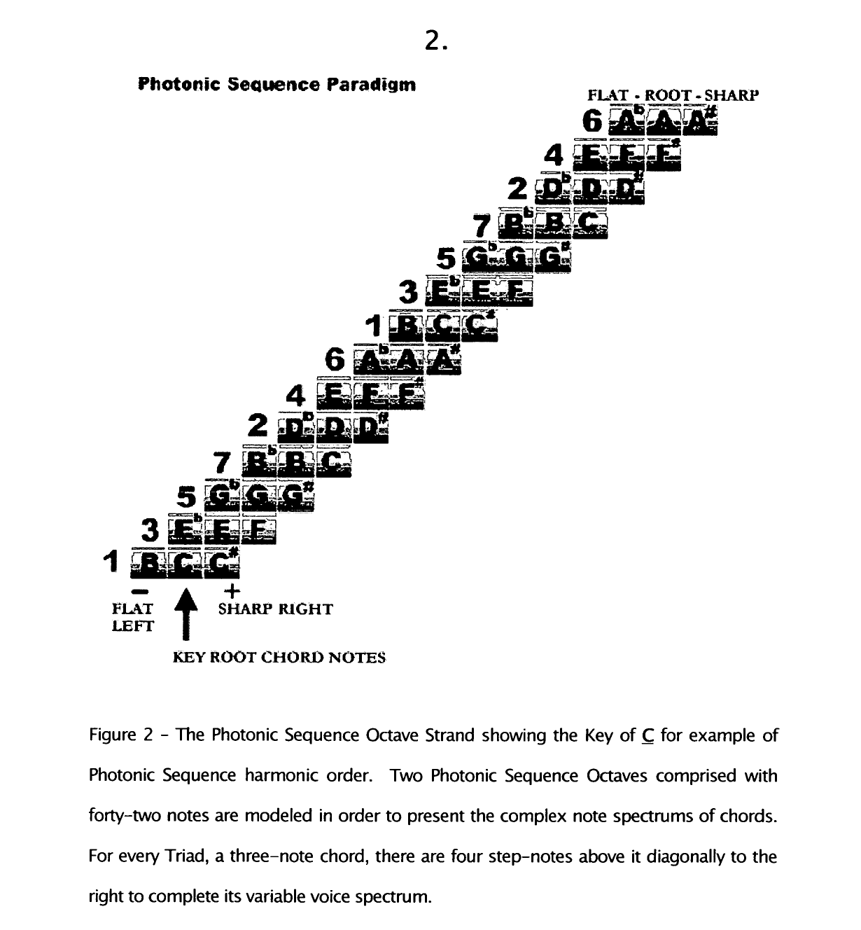

2. FIG. 2—Photonic Sequence C Strand showing an example of P.S. Note Order.

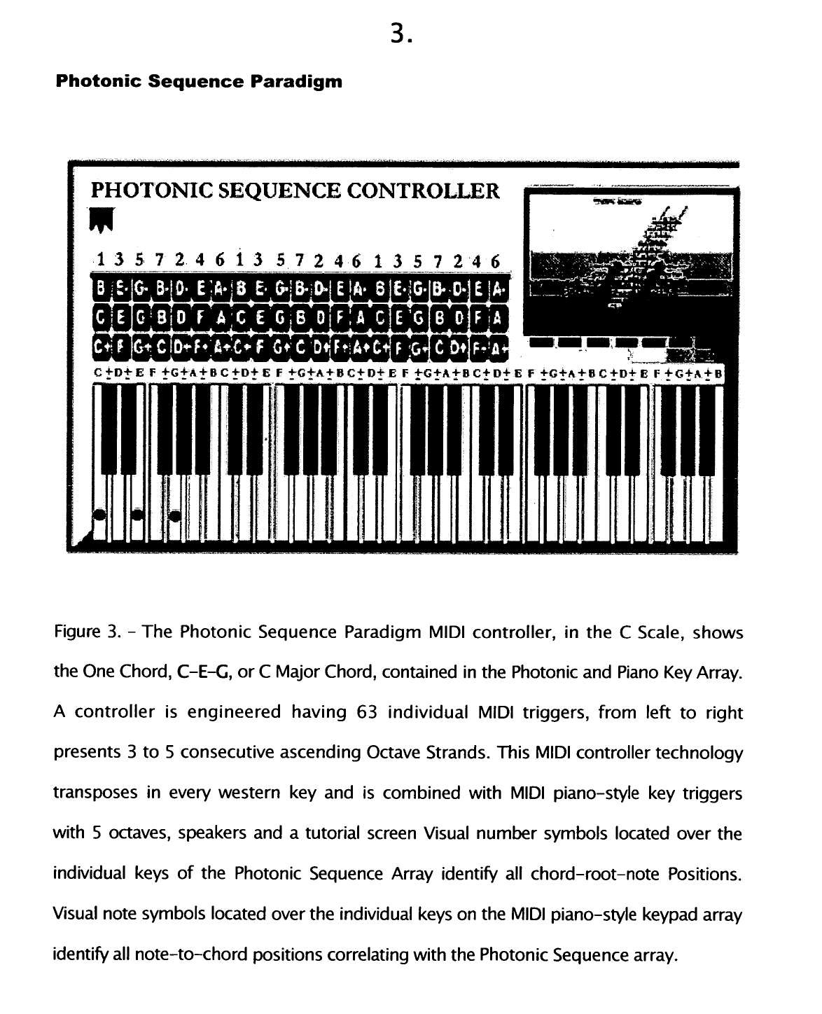

3. FIG. 3—Photonic Sequence MIDI Keyboard showing the Photonic Sequence Keypad Array located over the piano style keypad array combined with a video screen, programmable hardware with memory and software technology components to present instruction for Photonic Sequence and Music Theory, Piano, and other music instruments and to present Sheet Music, Staff, Notation, and Tablature.

### BRIEF DESCRIPTION OF THE INVENTION

The Photonic Sequence Paradigm is based on a mathematical algorithm that was used to establish a new music note order for Western Music Scales and was used to develop an advanced Twin-Axis Instructional Paradigm for Chord Theory. The Photonic Sequence Algorithm was used to engineer a novel midi-keyboard keypad that increases visual recognition of chord construction and chord flow. This greatly reduces the learning curve, by rapidly visually representing chord structure. Music note placement in the Photonic Sequence Order constructs obvious harmonic chord relationships by arranging individual music-notes of base chord construction in a daisy-chain sequence, or in a close proximity, which illustrates any chord's harmonic relationship for a simplified visual and tactile ability.

### DETAILED DESCRIPTION OF THE INVENTION

The Photonic Sequence Paradigm's is a Twin-Axis Graphic achieved by using Western Music Scales and stacking them in an alternating pattern to create a specific chord sequence based on the 1, 3, 5, 7, 2, 4, 6 chord root-notes. The Photonic Sequence Primary Axis contains the corresponding Flatted Note and Sharpened Note Semitones placed on either side of each chord's root-note. Starting with any chord root-note in the Photonic Sequence Paradigm Scale moving up Left to Right; the Second note is the Third note to the chord; the Third note is the Fifth; the Fourth note is the Seventh; the Fifth note is the Ninth; the Sixth note is the Eleventh; and the Seventh note is the Thirteenth note to the chord root-note. The Photonic Sequence Axis provides advanced visual and tactile recognition of musical chord structures by the note placement of harmonic structures in straight-line associations without unrelated semitones separating them. Notes are stacked vertically in multiple banks of three. These three notes located in each bank are in direct association with each other; they are the chord root-note, the chord root note's semitone flat and the semitone sharp. A Photonic Sequence Octave Strand (PSOS) is comprised with 21 notes and there is a Strand for each Western Music Twelve-tone Octave Scale. The PSOS has Seven Chord Root-notes of any Western Scale, plus the corresponding Seven Flat-notes, and Seven Sharp-notes, accounting for 21 notes. Of those twenty-one notes, nine are identical in their tonal value and are duplicated to enhance physical placement for visual and tactile recognition of chord structure. This provides a simplified note arrangement to assist music performance.

1. The Photonic Sequence Paradigm is an educational model for teaching harmonized scales of note-to-chord relationships. Clearly laid out in sequence graphics allow for simple explanation and visual recognition of the formulas for modal chord and characteristic note structures for each mode.

2. The Photonic Sequence Paradigm is an educational model according to claim 1; The Photonic Sequence Paradigm presents identical sequence of note-to-chord relationship for all basic and complex chords available in Western Music Scales by effectively linking music notes in sequence to enhance instant recognition, and observable dexterous placement. The Photonic Sequence algorithm presents these note-to-chord sequences for basic and complex chords for every western scale.

3. The Photonic Sequence Paradigm is an educational model according to claim 1; a MIDI-controller keypad array is engineered with Photonic Sequence for performing harmonic chord relationships through note-to-chord direct sequence.
